(19) United States
(12) Patent Application Publication
(10) Pub. No.: US 2015/0277087 A1
(43) Pub. Date: Oct. 1, 2015

(54) COMPACT MODIFIED RETROFOCUS-TYPE WIDE-ANGLE LENS

(71) Applicant: LEICA CAMERA AG, Wetzlar (DE)

(72) Inventors: Peter KARBE, Leun (DE); Dietmar STUIBLE, Wetzlar (DE)

(73) Assignee: LEICA CAMERA AG, Wetzlar (DE)

(21) Appl. No.: 14/671,297

(22) Filed: Mar. 27, 2015

(30) Foreign Application Priority Data
Mar. 28, 2014 (DE) 10 2014 104 457.6

(51) Int. Cl. G02B 13/04; G02B 27/00

(52) U.S. Cl. CPC G02B 13/04; G02B 27/0025

(57) ABSTRACT

A compact modified retrofocus-type wide-angle lens with a constant overall length during focusing is described, comprising, as seen from the object, a stationary front group (G1) with positive refractive power and a rear group (G2) with positive refractive power facing an image plane (IM), comprising an aperture stop (AP) arranged therebetween in a stationary manner, wherein the rear group (G2) consists of a first rear group portion (G2a) being displaceable along the optical axis and a second rear group portion (G2b) stationary in relation to the image plane (IM), wherein the first rear group portion (G2a) and the second rear group portion (G2b) have positive refractive power and the distance between the first rear group portion (G2a) and the front group (G1) reduces during focusing from infinity to close range.

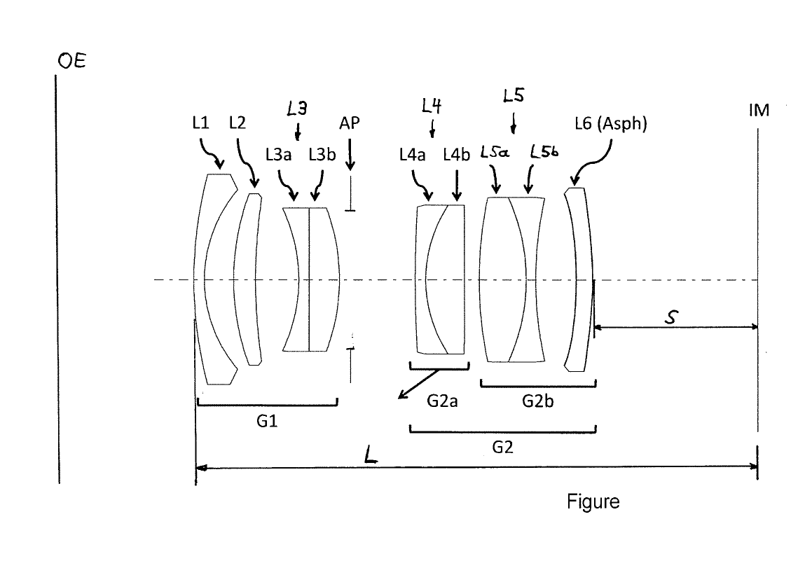

### CROSS-REFERENCE TO RELATED PATENT APPLICATIONS

Germany Priority Application 10 2014 104 457.6, filed Mar. 28, 2014 including the specification, drawings, claims and abstract, is incorporated herein by reference in its entirety.

### BACKGROUND

The invention relates to a photographic compact modified retrofocus-type wide-angle lens.

US 2013/0162886 A1 has disclosed a generic wide-angle lens with a constant overall length, which has, as seen from the object, a stationary front group with positive refractive power. A first rear group portion with positive refractive power is displaceable for focusing purposes and a second rear group portion with likewise positive refractive power has a stationary embodiment. An aperture stop is arranged between the front group and first rear group.

U.S. Pat. No. 5,909,319 A has disclosed a lens in which the overall length does not change over the whole focusing displacement. In the light direction, as seen from the object side, the lens has a first lens group with an overall positive refractive power, which contains a negative lens element. The second and third lens group, as seen in the light direction, each consist of a cemented component with negative refractive power and the fourth lens group has positive refractive power. The lens components two and three are mounted displaceably for focusing purposes.

DE 33 45 987 A1 has disclosed a telephoto lens, in which the front lens group has positive refractive power, the intermediate lens group has negative refractive power and a rear lens group has positive refractive power. The intermediate lens group is subdivided into two subgroups, wherein the lens is focused by moving the two subgroups toward the image side while changing the distance between the subgroups.

### SUMMARY OF THE INVENTION

Photographic retrofocus-type lenses usually have, as seen from the object, a front lens group with negative refractive power (front group) and a rear lens group with positive refractive power (rear group). Retrofocus-type lenses are also referred to as a reverse telephoto lens type. In these lenses, an aperture stop is usually arranged either between the front group and the rear group or within the rear group in order to restrict the opening of the incident beams. In such lenses, the whole lens group arranged behind the stop (rear group) is usually displaced axially in relation to the optical axis. Such lens groups to be moved for focusing purposes have a large weight and inertia is too high for e.g. autofocusing purposes. A strong motorization required in such lenses for autofocusing purposes generates high levels of noise and requires much current. Moreover, this type of focusing in retrofocus lenses causes aberrations, such as an astigmatic difference of focus, transverse chromatic aberration and field curvature, to amplify or change during focusing. Therefore, the correction state of the lens is insufficient, particularly in close range.

A further problem of these lenses is that the lengths of the focusing displacement are often unsuitable for fast focusing, as is required e.g. for autofocusing purposes.

It is one object of the invention to largely remove the field curvature and the transverse chromatic error, as are known in retrofocus-type lenses, and to avoid large aberrations and deterioration in the imaging quality during focusing.

A further object of the invention is to ensure a large opening, compact design, highest imaging power and a correction state of the lens which is as constant as possible over the whole distance focusing range, but in particular in close range up to an object distance of approximately 0.3 m, and, at the same time, improve the suitability to autofocusing purposes.

In a lens of the aforementioned type, these objects are achieved by the features described below.

In respect to the solution features, it should be noted that automatic correction programs, such as e.g. “code V” by Optical Research Associates, are usually used in modern optics design, which programs are able to calculate suggestions for functioning lens systems with a correction state optimized for a specific object from predetermined lens sequences and refractive power distributions. The automatically achieved correction state is further improved in each case on the basis of targeted modifications of the specified parameters by the optics designer.

In this manner, construction data for radii, lens element thicknesses, lens element spacings, refractive indices and Abbe numbers of the optical glasses to be used can already be obtained from the main features described below. It is possible to incrementally improve the structure parameters in a targeted manner by taking into account additional features specified below.

Further objects, features and advantages of the present invention will become apparent from the detailed description of preferred embodiments that follows, when considered together with the accompanying FIGURE of drawing.

### BRIEF DESCRIPTION OF THE DRAWINGS

The drawing depicts an exemplary embodiment of one lens according to the invention true to scale. Here, the FIGURE shows a lens element section through a lens when focusing on an object at infinity.

### DETAILED DESCRIPTION

The FIGURE depicts, as seen in the light direction, i.e. from an object (OE), the subdivision of the lens into a stationary front group (G1) with positive refractive power and a rear group (G2) with positive refractive power facing an image plane (IM). An aperture stop (AP) is arranged in a stationary manner between the front group (G1) and rear group (G2). The rear group (G2) consists of a first rear group portion (G2a) facing the aperture stop (AP) and being displaceable along the optical axis (depicted by dashes) for focusing purposes and a second rear group portion (G2b) stationary in relation to the image plane (IM). The first rear group portion (G2a) and the second rear group portion (G2b) have positive refractive power. The distance between the first rear group portion (G2a) and the front group (G1) reduces during focusing from infinity to close range. Improved suitability for autofocus purposes is achieved by a short focusing travel of less than 4 mm. The movement direction is depicted by an arrow specification at the reference sign G2a. In an alternative embodiment (not depicted in any more detail here), the refractive power of the second rear group portion (G2b) can be formed to be negative and, in a further variant, the front group (G1) can also be provided with negative refractive power. Using these embodiments, it is possible to implement compact modified retrofocus-type wide-angle lenses with a constant overall length, i.e. the overall length of the lens does not change during the focusing process, having particular suitability for autofocusing purposes.

In a preferred embodiment, the ratio of the focal lengths f1 of the front group (G1) and the focal length f2 of the rear group (G2) is greater than +3 in the case of a front group (G1) with positive refractive power and the ratio of the focal lengths −f1 of the front group (G1) and the focal length f2 of the rear group (G2) is less than −3 in the case of a front group (G1) with negative refractive power. Additionally, a ratio of the focal lengths f2 of the rear group (G2) to the focal length f2a of the first rear group portion (G2a) of between ⅓ and 3 was found to be particularly advantageous.

In an advantageous manner, the lens can be embodied in a particularly compact manner and with low costs and by performing a small correction effort if the front group (G1) has a weak negative overall refractive power of between e.g. −0.01 dpt and 0 dpt or a weak positive overall refractive power of between e.g. 0 dpt and 0.01 dpt. It is possible to achieve a small diameter of the aperture stop (AP) as a result of an overall positive refractive power of the front group (G1), in particular as a result of a positive refractive power of the third lens element (L3), which has an advantageous effect of a small outer diameter and a small overall length (L) from the lens vertex of the first lens component (L1) to the image plane (IM) of the lens.

The front group (G1) consists of three lens components (L1, L2, L3), wherein the first lens component (L1) has negative refractive power, the second lens component (L2) has positive refractive power and the third lens component (L3) has positive or negative refractive power. The lens components (L1, L2, L3) of the front group (G1) can respectively be implemented as a single-lens element or as cemented or separate lens element doublets (L3a, L3b), wherein the interaction of respective refractive indices of the first (L1), second (L2) and third (L3) lens components or lens element doublets (L3a, L3b) results in a refractive power corresponding to the overall refractive power of the front group (G1). The third lens component (L3) is preferably embodied as a lens element doublet made of a first planoconcave lens element with negative refractive power (L3a) and a second plano-convex lens element with positive refractive power (L3b). A positive overall refractive power of 1/240 dpt (focal length f1=240 mm) was found to be particularly advantageous for the front group (G1).

In further preferred embodiments, the first rear group portion (G2a) embodied as a focus group is constructed from a lens element (L4), two cemented single-lens elements (L4a, L4b) or two single-lens elements (L4a, L4b). In the case of the embodiment with two single-lens elements (L4a, L4b), it should be noted that the respective refractive powers of the single-lens elements (L4a, L4b) together result in an overall refractive power corresponding to the refractive power of the first rear group portion (G2a). Here, advantageously, the front single-lens element (L4a) is embodied as a convex-concave lens with negative refractive power and the rear single-lens element (L4b) is embodied as a biconvex lens with positive refractive power. In an optically particularly well corrected embodiment of the focusing group (G2a), the front single-lens element (L4a) or the rear single-lens element (L4b) of the first rear group portion (G2a) is displaceable along the optical axis in a manner separate from the actual focusing movement of the respectively other single-lens element (L4b or L4a) of the first rear group portion (G2a) as a floating element for the purposes of focusing from an infinite object distance to close range.

Advantageously, the second rear group portion (G2b) is formed from two lens components (L5, L6) with positive or negative refractive power. Both the first lens component (L5) and, simultaneously or alternatively, the second lens component (L6) can be held separately or embodied as a cemented component from respectively two single-lens elements (L5a, L5b and—not depicted in the FIGURE—L6a, L6b). Preferably, the second rear group portion (G2b) consists of a biconvex first lens (L5a) with positive refractive power and a biconcave second lens (L5b) with negative refractive power and it is embodied as a cemented component. The second lens component (L6) is advantageously embodied as a lens element with a one-sided or, particularly advantageously, with a two-sided aspherical surface curvature for reducing distortion.

The suitability of the lens according to the invention for autofocusing purposes is additionally improved by the balanced ratio of the mass of the first rear group portion (G2a) to the mass of the front group (G1) (mass G2a/mass G1) and of the mass of the first rear group portion (G2a) to the mass of the second rear group portion (G2b) (mass G2a/mass G2b), which is less than 0.7 in each case. The employed glass of the first rear group portion (G2a) weighs less than 3.6 gram while having a thickness of 5.5 mm in the region of the optical axis. The mass moving during the focusing process, which is thus kept low, promotes a quick electromechanical drive, requiring little energy, for the optical element (G2a) to be moved for focusing purposes. Particularly quiet autofocus movements are implementable in the case of such dimensions.

The setup and the refractive power distribution in the rear group (G2) enable a large back focus (S), which offers sufficient space for housing mechanical components such as, for example, a camera shutter (not depicted here) for digital photographic image recording. Thus, in the specific embodiment of the wide-angle lens described above, the back focus (S), i.e. the overall length between the last lens vertex of the second lens element (L6) of the second rear group portion (G2b), i.e. the aspherical lens element (L6) in the present case, facing the image plane (IM) is approximately 15.7 mm.

The wide-angle lens according to embodiments of the invention has a focal length (f′) between 20 mm and 25 mm at a relative aperture between 1:1.4 and 1:2.8. The focal length specification is dependent on a, or relates to a, predetermined and useable image recording diagonal of between 25 mm and 31.5 mm in the image plane (IM). Preferably, the ratio of the lens overall length (L), as measured from the lens vertex of the first lens component (L1) of the front group (G1) to the image plane (IM), to the focal length (f′) of the lens is greater than or equal to 2.0.

In the case of an APSC format image sensor with dimensions of 16 mm×24 mm, which is not depicted in any more detail in the image plane (IM) in the present case, the image diagonal useable for image recording is 28.4 mm. In this case, the focal length (f′) of the wide-angle lens is 23 mm, wherein the front group (G1) has a focal length of 240 mm. The ratio of the lens overall length (L) to the focal length (f′) of the lens corresponds to a value of 2.35. In this case, the lens overall length (L) is 54 mm.

The relative aperture does not depend on the image diagonal useable for the image recording and it is preferably 1:2.0 in the wide-angle lens according to embodiments of the invention. In this manner, a particularly compact lens with an unchanging good optical power is implementable.

The focusing range, obtainable via a focusing movement of the rear group portion (G2a) of 4 mm, extends from infinity to a near focusing limit that corresponds to four times the lens overall length (L).

It is self-evident that the lens underlying the invention is not restricted in its application to a specific sensor size of a camera since, when the optical setup of the invention is scaled, e.g. for the conventional format (24 mm×36 mm), the focal length ranges specified above for the APSC format emerge scaled by a corresponding format factor. This readily allows lenses with equivalent focal lengths between 30 mm and 40 mm to be realizable for the conventional format.

The diameter of the aperture stop (AP) can be reduced so as to further improve the imaging performance at close range, i.e. at a near focusing limit, which corresponds to four times the lens overall length (L), or therebelow. This measure likewise changes the aperture ratio of the lens. As a further measure for reducing the near focusing limit, the third lens component (L3) or the plano-concave lens element with a negative refractive power (L3a) or the planoconvex lens with positive refractive power (L3b) of the front group (G1) can be displaceable separately from the actual focusing movement of the first rear group portion (G2a) as a float element. As an alternative measure with the same purpose, the lens component (L5) or the biconvex lens element with positive refractive power (L5a) or the biconcave lens element with negative refractive power (L5b) of the second rear group portion (G2b) can be displaceable separately from the actual focusing movement of the first rear group portion (G2a) as a float element.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined with reference to the claims appended hereto.

### LIST OF REFERENCE SIGNS

L1 Lens element with negative refractive power
L2 Lens element with positive refractive power
L3 Lens element with positive or negative refractive power
L3a Plano-concave lens element with negative refractive power
L3b Plano-convex lens element with positive refractive power
L4 Focusing lens group with positive refractive power
L4a Convex-concave lens element with negative refractive power
L4b Biconvex lens element with positive refractive power
L5 Lens element with positive or negative refractive power
L5a Biconvex lens element with positive refractive power
L5b Biconcave lens element with negative refractive power
L6 Aspherical lens element
G1 Front group
G2 Rear group
G2a First rear group portion
G2b Second rear group portion
IM Image plane
OE Object plane
S Back focus
AP Aperture stop
L Lens overall length

What is claimed is:

1. A compact modified retrofocus-type wide-angle lens with a constant overall length, comprising, as seen from the object, a stationary front group (G1) with positive or negative refractive power and a rear group (G2) with positive refractive power facing an image plane (IM), comprising an aperture stop (AP) arranged therebetween in a stationary manner, wherein the rear group (G2) has a first rear group portion (G2a) facing the aperture stop (AP) and being displaceable along the optical axis for focusing purposes and a second rear group portion (G2b) stationary in relation to the image plane (IM), wherein the first rear group portion (G2a) has positive refractive power and the second rear group portion (G2b) has positive refractive power and the distance between the first rear group portion (G2a) and the front group (G1) reduces during focusing from infinity to close range and
the ratio of focal lengths f1 to f2 of the front group (G1) and the rear group (G2) is less than −3 or greater than +3 and the ratio of the focal lengths f2 to f2a of the rear group (G2) and the first rear group portion (G2a) lies between ⅓ and 3.

2. The wide-angle lens as claimed in claim 1, wherein the front group (G1) has three lens components (L1, L2, L3), wherein the first lens component (L1) has negative refractive power, the second lens component (L2) has positive refractive power and the third lens component (L3) has positive or negative refractive power and the lens components (L1, L2, L3) of the front group (G1) are respectively embodied as a single-lens element or as cemented or separate lens element doublets (L3a, L3b) with an overall refractive power corresponding to the respective refractive power of the first (L1), second (L2) and third (L3) lens components.

3. The wide-angle lens as claimed in claim 1, wherein the first rear group portion (G2a) embodied as a focus group has a lens element (L4), two cemented single-lens elements (L4a, L4b) or two single-lens elements (L4a, L4b), wherein the overall refractive power of the single-lens elements (L4a, L4b) corresponds to the refractive power of the lens element (L4).

4. The wide-angle lens as claimed in claim 1, wherein the second rear group portion (G2b) has two lens components (L5, L6) with positive or negative refractive power, wherein the first lens component (L5) and/or the second lens component (L6) has respectively two single-lens elements (L5a, L5b) and is either held separately or embodied as a cemented component.

5. The wide-angle lens as claimed in claim 1, wherein the ratio of the mass of the first rear group portion (G2a) to the mass of the front group (G1) or to the mass of the second rear group portion (G2b) is less than 0.7.

6. The wide-angle lens as claimed in claim 1, wherein the lens has a focal length (f′) between 20 mm and 25 mm at a relative aperture between 1:1.4 and 1:2.8 and the front group (G1) has a refractive power of 1/240 dpt, wherein the ratio of the lens overall length (L), as measured from the lens vertex of the first lens component (L1) of the front group (G1) to the image plane (IM), to the focal length (f′) of the lens is greater than or equal to 2.0.

7. The wide-angle lens as claimed in claim 4, wherein the second lens component (L6) of the second rear group portion (G2b) is embodied as an asphere.

8. The wide-angle lens as claimed in claim 6, wherein the focusing range extends from infinity to an object distance corresponding to four times the lens overall length (L) as near focusing limit.
